(19) United States
(12) Patent Application Publication
(10) Pub. No.: US 2009/0279904 A1
(43) Pub. Date: Nov. 12, 2009

(54) Enhancing Mono Printing Speed on a Single Pass Color Laser Printer

(76) Inventors: Cher Lek Toh, Singapore (SG); Sandeep Kumar Arya, Singapore (SG)

Correspondence Address: HAMILTON & TERRILE, LLP, P.O. BOX 203518, AUSTIN, TX, 78720, US

(21) Appl. No.: 12/117,843

(22) Filed: May 9, 2008

(51) Int. Cl. G03G 15/00

(52) U.S. Cl. 399/12

(57) ABSTRACT

A mono optimized color laser printer. The mono optimized color laser printer includes a provision in which mono toner cartridges may be inserted at each of four toner locations. The mono optimized color laser printer includes a mono optimization module which detects when mono toner cartridges are inserted into the four toner locations and controls printing so that each of the mono toner cartridges prints on about a quarter of a page. Such a mono optimized color laser printer reduces a time taken to transfer toner to the page to about a quarter that of a traditional color printer. Such a printer results in about a four times increase in printing speed for a mono print operation.

### BACKGROUND OF THE INVENTION

1. Field of the Invention

The present invention relates to information handling systems and more particularly to enhancing mono printing speed on a single pass color laser printer.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

One example of an information handling system is a laser printer such as a color laser printer. In a known single pass tandem color laser printer, the toner cartridges are stacked vertically. (See e.g., FIG. 1A, labeled Prior Art.) With this color laser printer, four toner cartridges: Black, Cyan, Magenta, and Yellow or K, C, M, and Y respectively, are installed at four predefined cartridge locations. The black toner cartridge is also referred to as a mono toner cartridge and the cyan, magenta, and yellow toner cartridges are referred to as color toner cartridges. When printing in color all four cartridges are engaged. However, when printing in mono (i.e., printing in black or grey scale using black toner only), only the black toner cartridge is engaged and the color cartridges are not. (See e.g., FIG. 1B, labeled Prior Art.)

With known printers, productivity (i.e., printer throughput) is an important purchasing consideration for customers. Known single pass color laser printer architecture achieves substantially the same speed when switching between color and mono modes, with the three-color cartridges disengaged. For certain heavy mono users, such as for text printing only, it would be advantageous to increase the mono print speed.

### SUMMARY OF THE INVENTION

In accordance with the present invention, a mono optimized color laser printer is set forth. The mono optimized color laser printer includes a provision in which mono toner cartridges may be inserted at each of the four-toner locations. The mono optimized color laser printer includes a mono optimization module which detects when mono toner cartridges are inserted into the four toner locations and controls printing so that each of the mono toner cartridges prints on about a quarter of a page. Such a mono optimized color laser printer reduces a time taken to transfer toner to the page to about a quarter that of a traditional color printer. Such a printer results in about a four times increase in printing speed for a mono print operation. The mono optimized color laser printer provides customers desiring increase mono printing speeds with the flexibility to improve print speed for mono in mono printing and hence save time.

In most single pass color laser architecture, one of the limitation in the speed is due to the imaging mechanism, such as the drum and laser module. The proposed solution to improve mono speed takes advantage of this fact by having all the mono cartridges working in tandem i.e. only a quarter of the page to be printed by each cartridge. In other words, print time for each page is reduced by about four times.

In one embodiment, the invention relates to a mono optimized color laser printer that includes a plurality of toner locations and a mono optimization module. A first toner location is configured to receive a mono toner cartridge. A second toner location is configured to receive either a mono toner cartridge or a color toner cartridge. The mono optimization module detects when a second mono toner cartridge is inserted into the second toner location and controls printing with the mono optimized color laser printer to use the first and second mono toner cartridges to print on respective portions of a print media.

In another embodiment, the invention relates to an information handling system that includes a processor, a memory coupled to the processor, a plurality of toner locations and a mono optimization module stored on the memory and executed by the processor. A first toner location is configured to receive a mono toner cartridge. A second toner location is configured to receive either a mono toner cartridge or a color toner cartridge. The mono optimization module detects when a second mono toner cartridge is inserted into the second toner location and controls printing with the mono optimized color laser printer to use the first and second mono toner cartridges to print on respective portions of a print media.

In another embodiment, the invention relates to a method for optimizing mono printing within a color laser printer. The color laser printer includes a plurality of toner locations. The plurality of toner locations encompasses configuring a first toner location being configured to receive a mono toner cartridge, configuring a second toner location to receive either a mono toner cartridge or a color toner cartridge, detecting when a second mono toner cartridge is inserted into the second toner location, and controlling printing to use the first and second mono toner cartridges to print on respective portions of a print media when optimizing mono printing on the color laser printer.

### BRIEF DESCRIPTION OF THE DRAWINGS

The present invention may be better understood, and its numerous objects, features, and advantages made apparent to those skilled in the art by referencing the accompanying drawings. The use of the same reference number throughout the several figures designates a like or similar element.

FIG. 1A, labeled Prior Art, shows a cross section view of an example single pass color laser printer.

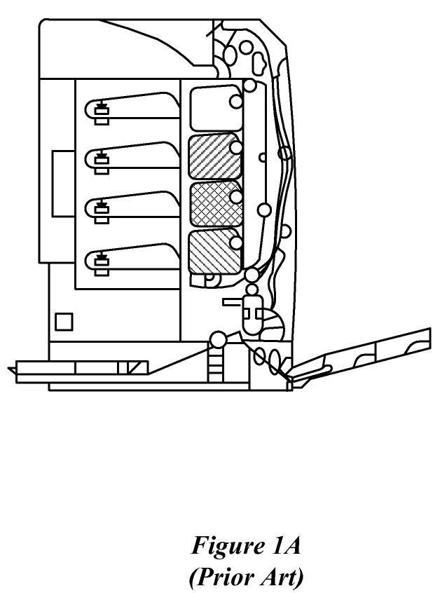

FIG. 1B, labeled Prior Art, shows a block diagram of a single pass color laser printer while performing a mono print operation.

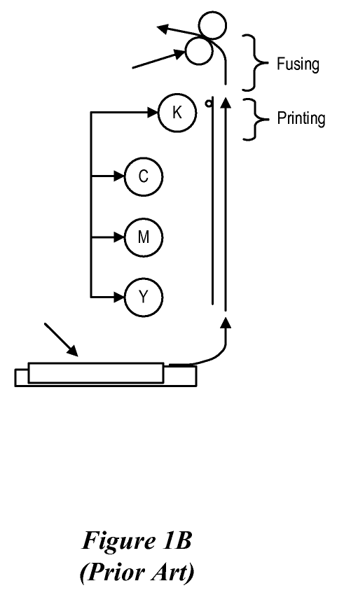

FIG. 2 shows a block diagram of an environment that includes a mono optimized single pass color laser printer.

FIG. 3 shows a cross section view of a mono optimized single pass color laser printer.

FIG. 4 shows a block diagram of a mono optimized single pass color laser printer.

FIG. 5 shows an example printer operation of a mono optimized single pass color laser printer.

### DETAILED DESCRIPTION

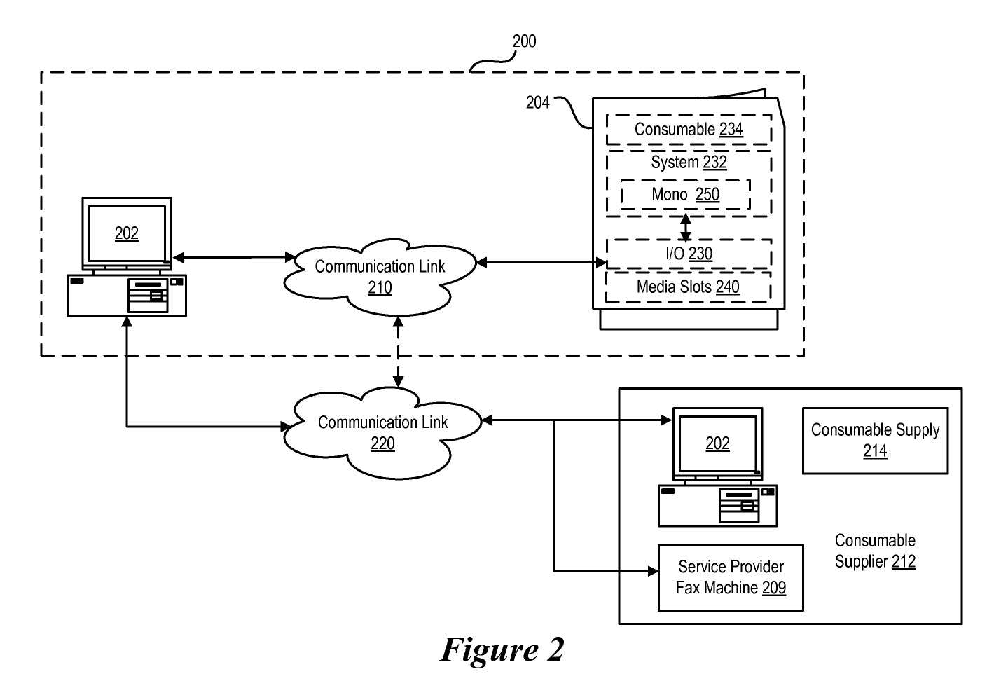

Referring to FIG. 2, a block diagram of an environment, which includes a mono optimized single pass color laser printer, is shown. The environment includes an information handling system 202 (such as a computer system or a camera) and a mono optimized color laser printer 204, coupled via a communication link 210. The communication link 210 might be a printer cable, a telephone cable, a network connection, or any other link which information is communicated with the printer 204. In one embodiment, the printer 204 is included within a multifunction device such as a combination printer fax machine. Other functions may also be included within the multifunction device such as a scan function and a copy function. In addition, in one embodiment, the environment does not include a computer system 202.

The mono optimized color laser printer 204 is coupled to a second communication link 220. Thus, communication may occur between the mono optimized color laser printer 204 and anything coupled to the second communication link 220 such as a services provider fax machine 209. Additionally, the computer system 202 is also connected to another computer system (e.g., a services provider computer system) 210 via a second communication link 220. The second communication link 220 may be a telephone system or some other type of network, such as the Internet. In one embodiment, the fax machine 209 and the computer system 210 are owned and operated by a consumable supplier 212. In this example, the service provider 212 may provide service for the mono optimized color laser printer 204.

The mono optimized color laser printer 204 includes an input output (I/O) port 230, a control system 232, and consumables 234. The I/O port 230 facilitates communications between the printer 204 and other devices connected to the communications link 210. The control system 232 provides the printer mono optimized color laser 204 with certain control functionality. The control system 232 includes a processor and memory coupled to the processor. The mono optimized color laser printer 204 may also include one or more media slots 240.

The consumables 234 represent any component in the mono optimized color laser printer 204 that is subject to depletion through use of the printer 204. For example, the consumable 234 may be the toner cartridges, etc. The service provider maintains a supply 214 of replacement consumables 234.

In operation, the computer system 202 generates a document in an electronic form and transmits the document (in the form of a print job) to the mono optimized color laser printer 204. The mono optimized color laser printer 204 receives the job via the I/O port 230 and prints the document. Additionally, when the mono optimized color laser printer 204 is part of a multifunction device, the mono optimized color laser printer 204 may receive and print information from the communication link 220 or from a scanned image when operating as a copier. Additionally, the mono optimized color laser printer 204 may receive and print information from any of its media slots 240.

The control system 232 of the mono optimized color laser printer 204 includes a mono optimization module 250 which detects when mono toner cartridges are inserted into the four toner locations and controls printing so that each of the mono toner cartridges prints on about a quarter of a page. Such a mono optimized color laser printer 204 reduces a time taken to transfer toner to the page to about a quarter that of a traditional color printer. Such a printer results in about a four times increase in printing speed for a mono print operation. The mono optimized color laser printer 204 provides customers desiring increase mono printing speeds with the flexibility to improve print speed for mono in mono printing and hence save time.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

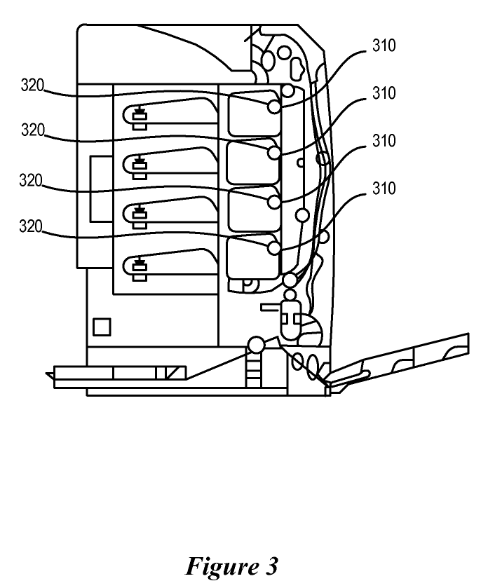

Referring to FIG. 3, a cross section view of a mono optimized single pass color laser printer 204 is shown. The mono optimized color laser printer 204 includes a provision in which mono toner cartridges 310 may be inserted into each of the four-toner locations 320. Each of the toner locations 320 include a provision for sensing whether an inserted toner cartridge is a mono toner cartridge or is a respective color toner cartridge. This information is provided to the mono optimization module 250.

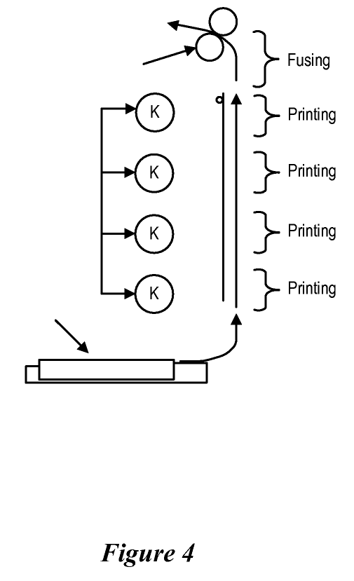

Referring to FIG. 4, a block diagram of a mono optimized single pass color laser printer is shown. More specifically, when mono toner cartridges are inserted into each of the toner locations 320, the mono optimization module 250 controls the cartridges such that all four mono toner cartridges are active (i.e., are engaged to present toner onto the paper) when performing a mono print job.

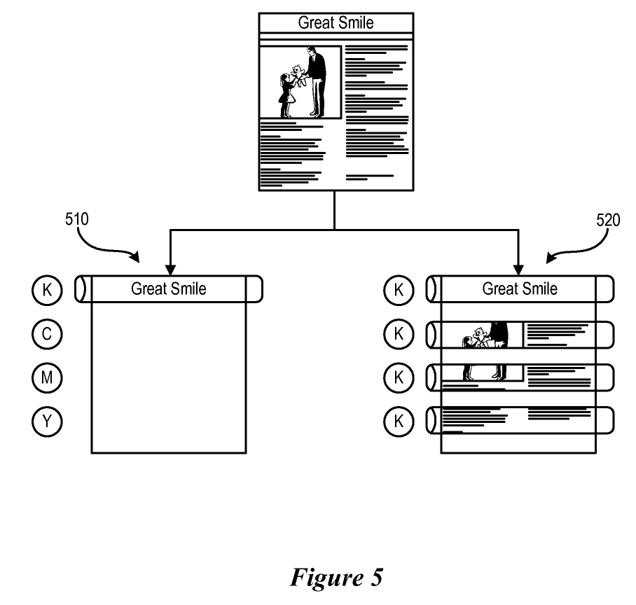

Referring to FIG. 5, an example printer operation of a mono optimized single pass color laser printer is shown. More specifically, the mono optimization module 250 determines whether the four mono toner cartridges are inserted into each of the four-toner locations. If only one mono toner cartridge is inserted (i.e., the color printer is arranged in a color print configuration) then the mono optimization module 250 causes the printer to print a mono print job using only the single mono toner cartridge. For example, print operation 510 represents how the single mono toner cartridge presents toner onto the paper.

However, if the mono optimization module 250 determines that four mono toner cartridge are inserted (i.e., the color printer is arranged in a mono optimized print configuration) then the mono optimization module 250 causes the printer to print a mono print job using all four mono toner cartridges. For example, print operation 510 represents how the four mono toner cartridges present toner onto the paper under control of the mono optimization module 250.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably, or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Also for example, while the present invention is described with respect to four mono toner cartridges inserted into respective toner locations, it will be appreciated that inserting two or three toner cartridges would also result in optimized mono printing. With these configurations, the mono optimization module 250 detects how many mono toner cartridges are inserted and controls the print job accordingly.

Consequently, the invention is intended to be limited only by the spirit and scope of the appended claims, giving full cognizance to equivalents in all respects.

What is claimed is:

1. A mono optimized color laser printer comprising:
a plurality of toner locations, a first toner location being configured to receive a mono toner cartridge and a second toner location being configured to receive either a mono toner cartridge or a color toner cartridge;
a mono optimization module, the mono optimization module detecting when a second mono toner cartridge is inserted into the second toner location, the mono optimization module controlling printing with the mono optimized color laser printer to use the first and second mono toner cartridges to print on respective portions of a print media.

2. The mono optimized color laser printer of claim 1 wherein:
the mono optimized color laser printer is configured in a single pass orientation.

3. The mono optimized color laser printer of claim 1 wherein:
the second toner location includes a provision for sensing whether an inserted toner cartridge is a mono toner cartridge or is a respective color toner cartridge; and,
information regarding whether an inserted toner cartridge is a mono toner cartridge or is a color toner cartridge is provided to the mono optimization module.

4. A mono optimized color laser printer of claim 1 further comprising:
third and forth toner locations, the third and forth toner locations being configured to receive either a mono toner cartridge or a color toner cartridge; and wherein
the mono optimization module detects when third and forth-mono toner cartridges are inserted into the third and forth toner locations, the mono optimization module controlling printing with the mono optimized color laser printer to use the third and forth mono toner cartridges to print on respective portions of a print media.

5. The mono optimized color laser printer of claim 4 wherein:
the second toner cartridge corresponds to cyan toner cartridge, the third toner cartridge corresponds to a magenta toner cartridge and the forth toner cartridge corresponds to a yellow toner cartridge; and,
each of the second, third and forth toner cartridge locations are configured to receive either the cyan toner cartridge, the magenta toner cartridge, the yellow toner cartridge, respectively, or a mono toner cartridge.

6. An information handling system comprising:
a processor;
a memory coupled to the processor;
a plurality of toner locations, a first toner location being configured to receive a mono toner cartridge and a second toner location being configured to receive either a mono toner cartridge or a color toner cartridge;
a mono optimization module stored on the memory and executed by the processor, the mono optimization module detecting when a second mono toner cartridge is inserted into the second toner location, the mono optimization module controlling printing with the mono optimized color laser printer to use the first and second mono toner cartridges to print on respective portions of a print media.

7. The information handling system of claim 6 wherein:
the plurality of toner locations are configured in a single pass orientation.

8. The information handling system of claim 6 wherein:
the second toner location includes a provision for sensing whether an inserted toner cartridge is a mono toner cartridge or is a respective color toner cartridge; and,
information regarding whether an inserted toner cartridge is a mono toner cartridge or is a color toner cartridge is provided to the mono optimization module.

9. The information handling system of claim 6 further comprising:
third and forth toner locations, the third and forth toner locations being configured to receive either a mono toner cartridge or a color toner cartridge; and wherein
the mono optimization module detects when third and forth-mono toner cartridges are inserted into the third and forth toner locations, the mono optimization module controlling printing with the mono optimized color laser printer to use the third and forth mono toner cartridges to print on respective portions of a print media.

10. The information handling system of claim 9 wherein:
the second toner cartridge corresponds to cyan toner cartridge, the third toner cartridge corresponds to a magenta toner cartridge and the forth toner cartridge corresponds to a yellow toner cartridge; and,
each of the second, third and forth toner cartridge locations are configured to receive either the cyan toner cartridge, the magenta toner cartridge, the yellow toner cartridge, respectively, or a mono toner cartridge.

11. A method for optimizing mono printing within a color laser printer, the color laser printer including a plurality of toner locations, comprising:
configuring a first toner location to receive a mono toner cartridge;
configuring a second toner location to receive either a mono toner cartridge or a color toner cartridge;
detecting when the second mono toner cartridge is inserted into the second toner location; and
controlling printing to use the first and second mono toner cartridges to print on respective portions of a print media when optimizing mono printing on a color laser printer.

12. The method of claim 11 further comprising:
configuring the plurality of toner locations in a single pass orientation.

13. The method of claim 11 further comprising:
sensing whether an inserted toner cartridge is a mono toner cartridge or is a respective color toner cartridge; and,
generating information regarding whether an inserted toner cartridge is a mono toner cartridge or is a color toner cartridge.

14. A method of claim 11 further comprising:
configuring third and forth toner locations being configured to receive either a mono toner cartridge or a color toner cartridge;
detecting when third and forth mono toner cartridges are inserted into the third and forth toner locations; and,
controlling printing to use the third and forth mono toner cartridges to print on respective portions of a print media when optimizing mono printing on the color laser printer.

15. The method of claim 14 wherein:
the second toner cartridge corresponds to cyan toner cartridge, the third toner cartridge corresponds to a magenta toner cartridge and the forth toner cartridge corresponds to a yellow toner cartridge; and,
each of the second, third and forth toner cartridge locations are configured to receive either the cyan toner cartridge, the magenta toner cartridge, the yellow toner cartridge, respectively, or a mono toner cartridge.
